(19) United States
(12) Patent Application Publication
(10) Pub. No.: US 2006/0160907 A1
(43) Pub. Date: Jul. 20, 2006

(54) Process for the treatment of palm waste

(76) Inventor: John Wesley Stamp, Queensland (AU)

Correspondence Address: CANTOR COLBURN, LLP, 55 GRIFFIN ROAD SOUTH, BLOOMFIELD, CT, 06002, US

(21) Appl. No.: 10/533,497

(22) PCT Filed: Oct. 30, 2003
(86) PCT No.: PCT/AU03/01435

§ 371 Date: Mar. 9, 2006

(30) Foreign Application Priority Data
Oct. 30, 2002 (AU) 2002952352
May 2, 2003 (AU) 2003902114

(51) Int. Cl. B01J 13/00

(52) U.S. Cl. 516/100

(57) ABSTRACT

A process for treating palm waste comprising the steps of a) shredding palm fibrous waste; b) blending the shredded palm fibrous waste with a dried plant mill effluent and peat.

The present invention relates to a process for the treatment of palm waste.

Palms are a plant of the family Palmae and are usually of great size having an unbranched trunk crowned by either pinnate or palmate fronds. There are about one thousand species known, nearly all of them growing in tropical or semitropical regions. The wood, leaves, saps, and fruit of many species are invaluable to the domestic economy of many countries worldwide. Among the best known are the cocoa palm, fan palm, wax palm, the palmyra, and various kinds called cabbage palm and palmetto. Better known are the oil, date and coconut palms being commodity cropped throughout East Asia, the Middle East and various parts of the African Continent. The cropping of all palms results in a considerable amount of biomass and waste. The biomass and waste is produced in a number of forms, the most significant being fronds of the palm from regular pruning, as well as empty fruit bunches. The majority of biomass and waste produced by the cropping of palms has not been dealt with in a satisfactory manner. For example, one of the favoured method of disposing of the fronds has been by burning. The burning of the fronds has resulted in much pollution and is considered unsatisfactory.

Other processes for the disposal of the fronds include the simple deposition in regions surrounding the crop where the biomass or waste is allowed to decay or break down over an extended period. Generally this approach is unsatisfactory as the biomass and waste tends to accumulate at a rate greater than that at which it decays.

As but one example, oil palm is a commodity crop in many countries and in particular throughout South-East Asia. The cropping of oil palm results in a considerable amount of biomass and waste. The biomass and waste is produced in a number of forms including the trunk of the palm after it has been felled, fronds of the palm from regular pruning, and empty bunches, shells, fibre and effluent from the processing of the full fruit bunches. Whilst mill effluent, filter cake (or mill mud) and washings, has been converted into useful by-products such as fertiliser, fuel, animal feed and biogas, the majority of biomass and waste produced by the cropping of oil palm has not been dealt with in a satisfactory manner. For example, one of the favoured method of disposing of the biomass and waste has been by burning. The burning of the biomass and waste has resulted in much pollution and is considered unsatisfactory. The burning of oil palm biomass and waste has now been banned in many countries, including Indonesia and Malaysia.

Similar to the processes employed for the disposal of the biomass or waste from date palms, the simple deposition of oil palms in regions surrounding the crop where the biomass or waste is allowed to decay or break down over an extended period.

In oil palm cropping there may be individual uses for each of the components of the oil palm waste, but there has yet to be proposed an integrated solution to the problem of processing oil palm waste in a manner that utilises the entirety of the waste material and produces by-products from the processing of oil palm crops that may find an economic and environmentally sustainable manner.

Other palm crops such as coconuts similarly generate significant quantities of waste, the use or disposal of which is not adequately provided for and is often simply left as a deposit to break down or decay over an extended period.

We have now found a process for addressing at least one of the disadvantages referred to above or at least providing the consumer with a useful or commercial choice.

According to one embodiment of the present invention there is provided a process for treating palm waste comprising the steps of:

a) shredding palm fibrous waste;

b) blending the shredded palm fibrous waste with a dried plant mill effluent and peat.

The process of the present invention may be used to produce a variety of different types of soil medium. In a particularly advantageous aspect the process of the present invention may be used to produce a number of different types of soil medium in proportions selected to consume the entire waste from a palm crop.

Soil types that may be produced in the process of the present invention range from high quality growing mediums to mulches and casing soil compositions. The growth mediums produced by the process of the present invention may be used in a wide range of applications including potting mixes, soil additive, mulch, mushroom casing soil and also as a top dressing material for germination of grass seeds.

Palms include a variety of species, being members of the monocoty ledonous family Arecaceae. Examples of palm species cropped in commercially significant quantities and which generate significant waste include oil palm, date palm and coconut palm.

Fibrous date palm waste typically includes palm fronds. Empty bunches that have been stripped of fruit are also fibrous waste produced from the processing of date palms. The fibre and shell from the fruit mass stripped from the empty bunches may be used as date palm fibrous waste in the process of the present invention.

Date palms have a commercial crop life of more than 20 years. After this period the date palm trees are removed and the next crop is planted. Date palm trunks are produced in an amount of about 75 tonnes per hectare. In the present invention the date palm trunks may be shredded. Typically the date palm trunks will be shredded separately from other fibrous date palm waste.

Fibrous oil palm waste includes palm trunks and palm fronds. Empty bunches that have been stripped of fruit are also fibrous waste produced from the processing of oil palms. The fibre and shell from the fruit mass stripped from the empty bunches may be used as oil palm fibrous waste in the process of the present invention.

Oil palms have a commercial crop life of approximately 25 years. After this period the oil palm trees are removed and the next crop is planted. Oil palm trunks are produced in an amount of about 75 tonnes per hectare. In the present invention the oil palm trunks are shredded. Typically the oil palm trunks will be shredded separately from other fibrous oil palm waste.

In one embodiment the palm trunks may be shredded in situ. At the end of their crop life, the fronds may be removed and a shredder disposed on an arm may shed the trunk from the top down. The shredded trunk material may be deposited on the ground for later collection or collected continuously in the shredder. In an alternative embodiment, the trunks may be cut down and fed into a horizontal shredder. Trunks that are cut down may be pulverised prior to shredding so as to improve the efficiency of the shredding process. The trunks may be pulverised using clasping jaws or grapples that are operated hydraulically on forestry machinery.

Palm fronds are obtained regularly throughout the life of a palm as part of regular pruning. Generally approximately 100 kg of fronds are pruned from each palm per year whilst from older palms the number of fronds obtained may be up to 150 kg. Palm fronds are also obtained from felled palms. Approximately 12 tomes of pruned fronds are produced per hectare per annum.

The fronds may be shredded by any convenient means. We have found that it is particularly convenient to feed the pruned fronds into a horizontally mounted shredder of the type that sprays the shredded material into a bin or pile for later collection.

It is preferred that the shredded material from the fronds of the palms have an average size in the range of from 2 mm to 10 mm. It will be appreciated that in order to increase the amount of larger shredded fibrous material such as is produced from the trunks of the palms, the average size of the shredded fronds may be increased. Dependent upon the type of soil mix being produced the size of the shredded material may be selected. For example in producing a high grade soil or growth medium, it may be preferred to have the shredded material at the lower end of the preferred size range, whilst in producing a mulch it may be preferred to have the shredded material at the higher end of the preferred size range.

It is preferred that the shredded material from the trunks of oil, date or other palms have an average size in the range of from 10 mm to 50 mm. Dependent upon the type of soil mix being produced the size of the shredded material may be selected. For example in producing a high grade soil or growth medium, it may be preferred to have the shredded material at the lower end of the preferred size range, whilst in producing a mulch it may be preferred to have the shredded material at the higher end of the preferred size range.

Empty bunches may be shredded by any convenient means. We have found that it is particularly convenient to feed the empty bunches into a horizontally mounted shredder of the type that sprays the shredded material into a bin or pile for later collection. Alternatively the empty bunches may be processed in a grinder or hammer mill.

It is preferred that the shredded material from the empty bunches of the palms have an average size in the range of from 2 mm to 10 mm. Dependent upon the type of soil mix being produced the size of the shredded material may be selected. For example in producing a high grade soil or growth medium, it may be preferred to have the shredded material at the lower end of the preferred size range, whilst in producing a mulch it may be preferred to have the shredded material at the higher end of the preferred size range.

The shredded palm fibrous material may also be in the form of fronds, trunks and husks derived from coconut palms.

The dried plant mill effluent may be derived from any convenient source. For example the dried plant mill effluent may be derived from sugar cane and be in the form of dried mill mud. The term “sugar cane mill mud” in the present specification and claims refers to washing material from sugar cane mills. The washings include cane washings, lime, cane juice impurities and fine bagasse.

Typically, sugar cane mill mud has the following composition:

TABLE 1
SUGAR CANE MILL MUD

| Nutrient/Test | Analytical Range |
|---|---|
| Moisture Level % | 67.9-75.5 |
| Water holding capacity % | 46.9-62.3 |
| pH | 5.8-6.4 |
| Electrical conductivity | 0.54-0.77 |
| Total Nitrogen % dm | 0.52-0.83 |
| Ammonium Nitrogen ppm | 5-45 |
| Phosphorus % dm | 0.45-0.69 |
| Potassium % dm | 0.69-0.89 |
| Calcium % dm | 1.01-1.53 |
| Magnesium % dm | 0.37-0.43 |
| Sulfur % dm | 0.13-0.19 |

The dried plant mill effluent may also be dried effluent from an oil palm processing plant or a date palm processing plant. For example, the fruit mass stripped from the fruit bunches of an oil palm may be combined with water. For every 13.2 tonnes of fruit ( the approximately amount produced per hectare per annum) 5.6 tonnes of water is used. The processing of the fruit mass yields about 14.4 tonnes of oil and sludge.

About 2 tonnes of nut is yielded from the processing of the fruit mass.

The nut is typically combined with about 1 tonne of water for processing. This processing yields about 1 tonne of oil (the economic product produced by the oil palm crop), about 1 tonne of shell and about 1 tonne of nut washings. The washings form part of the effluent.

The about 14.4 tonnes of oil and sludge yielded from the fruit mass is process to produce about a further 4.4 tonnes of oil and the process also yields about 10 tonnes of sludge. The sludge is combined with a sterilizer condensate and the nut washings to give about 13.4 tonnes of effluent. The effluent may be dried by any convenient means. The effluent may be conveniently dried in a mixer where the effluent is stirred or turned during the drying process. Suitable mixers include rotating bowl mixers of the type used in mixing cement. The effluent may also be dried in a pan type drier that relies solely on evaporation for drying. It is particularly preferred that the effluent be subjected to heating during the drying process to increase the drying rate and the extent of the drying of the effluent.

The effluent may be separated into mill mud and washings prior to drying. The mill mud may be dried separately to the washings and similar process to those described above may be used to dry either or both of the mill mud and the washings.

The mill effluent is preferably dried at a temperature in the range of from 80° C. to 200° C.

The dried effluent and the shredded palm fibrous material are blended with peat.

The peat may preferably be “non-sphagnum” peat. Non-sphagnum peat includes any peat material that is not derived from sphagnum moss. Such peat material includes peat derived from sedges or trees, another suitable peat is cocoa peat derived from coconut fibre. Typically cocoa peat consists of shredded coconut coir (the fibrous part of the coconut shell). The coconut fibre may be either partially composted or used in its raw state. Other types of peat such as Indonesian peat and Malaysian peat may also be used in the process of the present invention. Combinations of any two or more types of peat and or coconut fibre may also be used.

The blending process may be performed in any convenient mixer. Suitable mixers include rotating bowl mixers of the type used in mixing cement. Other mixers may be used from basic mixing arrangements such as a front end loader turning the materials using its scoop to sophisticated blending equipment.

The dried effluent and the shredded fibrous material may be blended with peat in presence of a wetting agent. We have found that the use of a wetting agent is particularly advantageous in the production of a soil medium as the wetting agent allows the mixed soil medium to pick up and retain a desired amount of water. For example, the blended soil medium may comprise: 1 tonne of the blend of dried effluent, shredded fibrous material and peat; 1 litre of wetting agent and 10 litres of water. One such wetting agent is Safeclean supplied by J T Distributors of Carole Park, Queensland, Australia.

Dependent upon the type of soil medium to be produced using the process of the present invention the proportions of the respective components may be adjusted. The ratio of peat to dried effluent generally applies to the production of all types of soil medium. The volume ratio of peat:dried effluent is generally in the range of from 50:50 to 75:25, preferably in the range of from 60:40 to 70:30. In the production of a high quality growing medium shredded fibre may be present in an amount in the range of from 10% to 20% by volume, preferably in the range of from 15% to 20%. In the production of a mulching medium shredded fibre may be present in amounts up to about 80% by volume. It will be appreciated that a variety of mediums for different applications may be produced between the growing medium and the mulching medium.

Optional additives may also be blended with the shredded fibre, dried effluent and peat. Such additives include wetting agents, fungicides, nematicides, insecticides and texture and pH controlling agents. Such additives are known to those skilled in the art. The composition may also be supplemented with nutrients, if desired, although it is preferred to balance the nutrients by the use of the shredded fibre, dried effluent and peat in selected amounts.

Where the medium is to be used as a plant growth medium such as potting mix or top dressing soil, it may be desirable to add a filler material to modify porosity and/or water retention. The amount of filler can be varied, depending upon the desired properties of the mix. This can depend on the type of plant to be grown. Suitably, about 30 to about 80 wt % of filler may be added. Potting mixes will typically include about 60 to about 70 wt % filler where top dressing soils can contain lower levels of filler.

A preferred filler is an inert material.

In order that the invention may be more fully understood and put into practice, preferred embodiments thereof will now be described with reference to the following non-limiting examples.

### EXAMPLE

We mixed and compared 3 different growing mediums using palm waste in one of them to grow vegetables and compare growth rate. The three mediums were,

1. Supersoil® (growing medium from date palm waste composition described below);

2. Processed clay;

3. Waste from prawn farm ponds.

The Supersoil® mix consisted of 550 kg of Peat, 350 kg of oil palm mill mud, and the balance being 100 kg in fibre from shredded date palm fronds. This was mixed slowly in a commercial concrete mixer and during mixing we added 1 litre of concentrated wetting agent in 10 litres of water, this was done to give it a much better water retention. The finished product was placed in a large container adjacent to the other growing mediums and controlled growing tests were carried out.

The Supersoil® mix obtained double the growth rate of the other mediums. We observed that we also had a far healthier plant free of insects and diseases. We used the same amount of water on all samples of growing mediums during the tests and we had a much better retention rate and therefore we had a better growth rate.

Persons skilled in the art will appreciate that the present invention relates to all species of palm waste and may be subject to improvements and modifications that will be apparent without departing from the spirit and scope of the invention described herein.

1. A process for treating palm waste comprising the steps of:
a) shredding palm fibrous waste;
b) blending the shredded palm fibrous waste with a dried plant mill effluent and peat.

2. A process according to claim 1 wherein the palm fibrous waste is an oil palm waste selected from the group consisting of oil palm fronds, empty oil palm bunches, oil palm trunks, oil palm fibre and shell stripped from oil palm bunches.

3. A process according to claim 1 wherein the palm fibrous waste is a date palm waste selected from the group consisting of date palm fronds, empty date palm bunches, date palm trunks, date palm fibre and shell stripped from date palm bunches.

4. A process according to claim 1 wherein the palm fibrous waste is a coconut palm waste selected from the group consisting of coconut palm fronds, coconut palm trunks and coconut palm husks.

5. A process according to claim 1 wherein the palm fibrous waste includes palm fronds shredded to an average size in the range of from about 2 mm to about 10 mm.

6. A process according to claim 1 wherein the palm fibrous waste includes palm trunks shredded to an average size in the range of from about 10 mm to about 50 mm.

7. A process according to claim 1 wherein the palm fibrous waste includes empty palm bunches shredded to an average size in the range of from about 2 mm to about 10 mm.

8. A process according to claim 1 wherein the dried plant effluent is selected from the group consisting of dried sugar cane mill mud, dried oil palm mill effluent and dried date palm mill effluent.

9. A process according to claim 1 wherein the peat is a “non-sphagnum peat”.

10. A process according to claim 9 wherein the peat is derived from at least one of sedges or trees, cocoa peat, Indonesian peat and Malaysian peat.

11. A process according to claim 1 wherein the shredded palm fibrous waste, dried plant mill effluent and peat are blended in a rotating bowl mixer.

12. A process according to claim 1 wherein the dried effluent and the shredded fibrous material are blended with peat in presence of a wetting agent.

13. A process according to claim 1 wherein the shredded fibrous palm material is present in the blend in the range of from about 10% to about 20% by volume.

14. A process according to claim 13 wherein the shredded fibrous palm material is present in the blend in the range of from 15% to 20%.

15. A process according to claim 1 wherein a volume ratio of peat:dried effluent is in a range of from 50:50 to 75:25.

16. A process according to claim 1 wherein a volume ratio of peat:dried effluent is in a range of from 60:40 to 70:30.
